(19) United States
(12) Patent Application Publication
(10) Pub. No.: US 2014/0304109 A1
(43) Pub. Date: Oct. 9, 2014

(54) METHOD WITH AN EVENT MANAGEMENT DEVICE

(71) Applicant: QRMobiTec GmbH Innovationszentrum IZE, Engen-Welschingen (DE)

(72) Inventors: Ralf Stokar von Neuforn, Reichenbach (DE); Thomas Ernest Kramer, Munchen (DE); Wolfgang Reinertz, Aach (DE); Dieter Sessler, Aach (DE)

(73) Assignee: QRMobiTec GmbH Innovationszentrum IZE, Engen-Welschingen (DE)

(21) Appl. No.: 14/155,438

(22) Filed: Jan. 15, 2014

(30) Foreign Application Priority Data
Apr. 8, 2013 (DE) 10 2013 103 453.5

(51) Int. Cl. G06Q 30/06

(52) U.S. Cl. CPC G06Q 30/0633
USPC 705/26.8

(57) ABSTRACT

An event capturing device receives event-relevant information, searches the event-relevant information for an event by means of an event description and sends a captured event to an event management device. The event management device filters the captured event by means of at least one filter rule. An offeror information, dependent on the filtered event and sent by an offeror information device, is sent to a mobile computing device. The mobile computing device carries out at least one event function which at least partially presents the offeror information to an end user, captures an end user input and sends the end user input to the event management device. The event management device carries out a processing procedure sends an order for a financial transaction to a financial transaction device and sends an order for a dispatch of goods to the offeror information device.

### PRIOR ART

The invention relates to a method according to the preamble of claim 1.

An augmented-reality method with a mobile computing device which sends at least one event-relevant information, with an event management device which at least receives the event-relevant information and sends an offeror information, which is dependent on a captured event of the event-relevant information, to the mobile computing device, has already been proposed.

The objective of the invention is in particular to provide a method which, at a low total computing effort, has an influence on the real world, which influence is advantageous to an end user. According to the invention, the objective is fulfilled by the features of claim 1, while advantageous embodiments and further developments of the invention may be gathered from the subclaims.

### Advantages of the Invention

A method is proposed with a mobile computing device which sends at least an event-relevant information, wherein an event capturing device receives the event-relevant information, searches the event-relevant information for an event by means of an event description and sends the captured event to an event management device, wherein the event management device on receiving the captured event carries out a filter function which filters the captured event by means of at least one filter rule, wherein an offeror information, which is dependent on the filtered event and has been sent by an offeror information device, is sent to the mobile computing device, wherein the mobile computing device, in dependence on the offeror information, carries out at least one event function which at least partially presents the offeror information to the end user, captures an end user input and sends the end user input to the event management device, wherein the event management device carries out a processing procedure which is dependent on the end user input and influences the real world by sending an order for a financial transaction to a financial transaction device and sending an order for a dispatch of goods to the offeror information device.

A “mobile computing device” is intended to be understood as a computer which is deemed expedient by a person skilled in the art and is portable and/or movable during operation, advantageously however as a laptop computer, a tablet computer, a mobile phone, data glasses, a motor vehicle, in particular a passenger car, a motorbike, a bus or a motor truck, and/or a smartphone as well as combinations of such computing devices. As an alternative, the mobile computing device and the motor vehicle could be implemented in one piece or the mobile computing device could be connected to the motor vehicle via an interface for exchanging data. Preferably the mobile computing device comprises a processor, a memory, an operating means and an operating system. Preferentially the mobile computing device further has at least one event capturing application. The event capturing application is implemented as an end user application, as an offeror application and/or as an event recognizing application. In particular, the event capturing application is implemented as an “app”. The event capturing application is preferably implemented as an independent executable program. As an alternative, the event capturing application could be implemented as a plug-in of a further program that is deemed expedient by the person skilled in the art. In particular the event capturing application is implemented as a “hybrid app”. A “hybrid app” is intended to mean in particular a computer program that has a basis routine provided for connection with a hardware and an operating system of the mobile computing device, at least an application configuration and in particular an event function routine. The basis routine and the event function routine communicate via an interface. As an alternative, the basis routine and the event function routine could be implemented as a single program. The basis routine is implemented as a routine deemed expedient by the person skilled in the art, in particular however as an in particular adapted Apache-Cordova instance, as a Sencha instance, as a Corona instance, as a Titanium instance, as a Dojo Toolkit instance, as a jQueryMobile instance and/or especially advantageously as a PhoneGap instance. In particular an implementation of the basis routine is dependent on an operating system, e.g. Android or iOS, and/or in particular on a hardware of the mobile computing device. The application configuration describes at least a presentation and advantageously a function of the end user interface. The application configuration advantageously has an offeror application configuration and in particular an offeror capturing configuration if the application is configured as an offeror application. The offeror application configuration configures a presentation of the offeror application. The offeror capturing configuration configures a capturing of the event-relevant information of the offeror application by means of the event management device. The application configuration advantageously has an end user capturing configuration if the application is embodied as an end user application. The application configurations are modifiable by the end user and/or by the offeror. The application configuration comprises HTML elements, advantageously HTML5 elements, CSS elements, advantageously CSS3 elements, and/or JavaScript elements. By means of the HTML elements, in particular sensors of the hardware can be accessed. Preferably the application configuration comprises texts, media as for example images or videos, and/or references to media. The event function routine is implemented as a plug-in of the basis routine. The event function routine is designed to provide further functionalities, in particular for communication with the event management device. Preferentially the basis routine and/or the event function routine is provided to load different application configurations, thus providing a variety of functionalities and/or presentations. The event function routine is in particular provided to compose and send an information package containing the event-relevant information, in particular when an event is captured. Advantageously the mobile computing device has sensors implemented as at least a microphone, a camera, a 3D camera, a clock, an acceleration sensor and/or a satellite navigation means. Alternatively or additionally the mobile computing device could be provided for capturing the event-relevant information from a sensor which is deemed expedient by the person skilled in the art, e.g. from a heart rate monitor, a medicinal sensor and/or a sensor of a motor vehicle. The mobile computing device is in particular provided to communicate via a wireless network that is deemed expedient by the person skilled in the art, advantageously however via a mobile communications network, e.g. UMTS or LTE. An “event-relevant information is in particular intended to mean an information or an information flow which describes the real word and which, during operation, is searched whether a real-world event has taken place. Advantageously the event-relevant information is an information deemed expedient by the person skilled in the art, especially advantageously a position of the mobile computing device, a real-time of the mobile computing device, a sound signal recorded by the mobile computing device, a freeze frame taken by the mobile computing device, a 3D image recorded by the mobile computing device and/or preferably an in particular two- or three-dimensional video signal recorded by the mobile computing device.

An “event management device” is in particular intended to be understood as a device which is provided to react to an event comprised in the event-relevant information in dependence on an end user input. Preferentially the event management device has at least one interface for communication with the mobile computing device. The interface is in particular provided as an interface that is deemed expedient by the person skilled in the art, it is however implemented advantageously as an XML-RPC interface, as an SOAP interface and/or especially advantageously as a RESTful interface. The mobile computing device and the event management device communicate via the interface synchronously or asynchronously. In the case of synchronous communication via the interface, after each question sent an answer is sent. In the case of asynchronous communication an answer may follow after a plurality of questions. Advantageously the event management device has at least one interface for communication with a configuration computing device. The event management device preferably has at least one interface for communication with an offeror information device. In particular the event management device has at least one interface for communicating with an event capturing device. An “interface” is to be understood as a software means and/or hardware means for communication by way of a defined protocol (API). Preferably the event management device communicates by the interface via a WAN (Wide Area Network), in particular the internet. The interface is in particular implemented at least partially by the event function routine of the event capturing application. By a “captured event”, in this context, in particular an information is to be understood which describes factual circumstances in the real world. Preferentially the event management device detects the event by searching the event-relevant information for the event by means of an event description. For example, a captured event may be an identification of a motor fault, based on a sound recording of the motor and on an event description allocated to the fault, e.g. a spectrum of the sound recording which is typical for the fault. An “event description” is intended to mean in particular an information describing an event that is to be captured. The event management device preferably searches the event-relevant information for matches with the event description. In particular the event management device and/or in particular the event capturing device determines a matching value which depends on a similarity of at least a portion of the event-relevant information and the event description. If this matching value exceeds a threshold value that is deemed expedient by the person skilled in the art, the event is taken as captured. The event description has in particular an indexing information which is provided for quick searching.

By an “offeror information” in particular an information supplied to the end user by an offeror of a service is to be understood. The offeror information in particular comprises HTML elements, advantageously HTML5 elements, CSS elements, advantageously CSS3 elements, and/or JavaScript elements. In particular the event function is provided to receive the offeror information and to forward it to the basis routine. The basis routine in particular combines the offeror information with the application configuration, and/or the basis routine substitutes the application configuration with the offeror information. The offeror information can consist of one or several transmitted message or messages which is or are embodied as data packages. The offeror information comprises an information which is deemed expedient by the person skilled in the art, preferentially however a product information, e.g. an operating information, a purchase information and/or a spare part information. Preferentially the offeror information comprises an end user input configuration, e.g. a menu structure or an input dialogue structure, or a reference to such data which are advantageously retrievable by way of the internet. Moreover, the offeror information advantageously has an event description, especially advantageously an event description the capturing of which requires low computing effort, e.g. a time description and/or a location description. In particular the offeror information comprises a medium which is deemed, by the person skilled in the art, to be expedient for a presentation, e.g. a text, an image, a sound track, a 3D model and/or a video or a reference to a medium which is preferentially retrievable by way of the internet.

The term “dependent” is intended to mean, in particular, that the respective information is evaluated and an evaluation result influences a following method step. An “event function” is intended to mean in particular a function, in particular of the event function routine, which is carried out when an event is recognized. The event function is in particular carried out when the offeror information is received. Preferentially the event function is at least provided to present the medium and/or the menu of the offeror information, in particular by means of the basis routine and advantageously of the application configuration. The event function is in particular provided to send end user inputs, which have in particular been captured by means of the basis routine, to the event management device. Preferably the event function is provided to at least partially present an, in particular further, offeror information received after an end user input to the end user, in particular by means of the basis routine and advantageously by means of the application configuration. In particular the term “receive an end user input” is intended to mean that the event function allocates, in particular by means of the basis routine and advantageously of the application configuration, a functional meaning to an information obtained by an activity of the end user. Herein the end user input may be carried out by the input means as well as by internal and/or external sensors, as e.g. via the microphone, the camera, the acceleration sensor and/or a satellite navigation means.

A “processing procedure influencing the real world” is in particular intended to be understood as a procedure which is at least suitable for controlling an appliance, influencing a behavior of the end user or advantageously influencing a payment or a delivery of goods. Preferentially the processing procedure influences the real world at least via the event management device. The processing procedure is for example implemented as a dispatch of an order.

In a further embodiment it is proposed that an event capturing device searches the event-relevant information for an event. Hereby a maximum portion of the computing effort is not carried out on the mobile computing device, which in particular prolongs an accumulator runtime of the mobile computing device. By an “event capturing device” in particular a device is intended to be understood which is provided to detect an event in an information flow describing the real world by the event description that describes the event. The event capturing device is preferably provided to recognize the event description, e.g. an image or a 3D model, in an event-relevant information, for example in a video track recorded by the camera of the mobile computing device. Preferentially the event capturing device has an interface by way of which the event capturing device receives the event-relevant information advantageously from the event management device and/or alternatively directly from the mobile computing device. The event management device preferably forwards the event-relevant information to an event capturing device. Advantageously, the event capturing device has an interface by means of which the event capturing device sends the captured event advantageously to the event management device and/or alternatively to the mobile computing device. In particular the event capturing device and the event management device are embodied separately. The event management device and/or in particular the mobile computing device advantageously has an event capturing function. In particular the event capturing function of the event management device and/or advantageously of the mobile computing device could be provided to capture an event in an event-relevant information that requires low computing effort, as for example a capturing of a place and/or of a time.

The event capturing device preferably sends the captured event directly to the event management device. As an alternative, the event capturing device could send the captured event to the event management device via the mobile computing device.

In particular, a “filter function” is intended to be understood as a function which checks whether the captured event and advantageously additional event information allocated to the captured event are in accordance with a schema to which an offeror information and/or an implementation of the event function on the mobile computing device is assigned. The filter function is preferably provided to further process a captured event in different ways, depending on the filter rule, for example to block the captured event or to start the event function on the computing device. In particular the filter function is provided to block a process that follows filtering if the captured event and the information allocated to the captured event do not comply with the filter rules. An “additional event information” is in particular to be understood as an information which describes the event in detail, e.g. a place of the event, a time of the event and/or an end user information. By an “end user information” in particular an information is to be understood which describes an end user of the mobile computing device, for example a behavior, characteristics, an allocation to a group e.g. a social network, and/or interests of the end user. The mobile computing device and/or the event management device is preferably provided to capture end user information, e.g. by a surfing behavior and/or shopping behavior. Alternatively or additionally the end user could make the end user information available, for example by entering the end user information in particular into the mobile computing device. By a “filter rule” in particular an information is to be understood which describes which event, in dependence on the event and on additional event information, is further processed following which procedure, e.g. blocking or documenting the event, or whether the event carries out the event function on the computing device. A “filtered event” is to be understood in particular as an information which has not been blocked by the filter, and which comprises at least the captured event and advantageously at least a portion of the additional event information.

By “at least partially present” it is in particular to be understood that the event function, in particular by means of the basis routine and advantageously of the application configuration, processes the offeror information for presentation and presents it to the end user via a loudspeaker and/or advantageously via a display of the mobile computing device.

An “end user input information” is in particular intended to be understood as an information that is dependent on an end user input, e.g. a text written by the end user and/or advantageously an element of a menu presented to the end user, which element has been selected by the end user.

By the implementation according to the invention an influence on the real world, which is advantageous for the end user, can be achieved at especially low computing effort. In particular the offeror can advantageously connect real-world characteristics and the end user input for influencing the real world.

Moreover it is proposed that the event management device receives the offeror information from an offeror information device, whereby current information, which has been adjusted to the captured event, can advantageously be presented to the end user. Alternatively or additionally the mobile computing device could receive the offeror information, at least partially, directly from the offeror information device and/or advantageously request the offeror information from the offeror information device, in particular by means of a reference. An “offeror information device” is to be understood in particular as a system which is provided to at least partially provide the event management device with the offeror information which the event management device transfers to the mobile computing device. The offeror information device is embodied as an information system which is deemed expedient by the person skilled in the art and which has information maintained by the offeror, preferably as an information database and/or especially preferably as a merchandise management system, for example an SAP-ERP system. The offeror information device preferably has an interface via which the offeror information device transfers at least portions of the offeror information to the event management device. Advantageously the offeror information device is embodied as an information distribution network (Content Delivery Network “CDN”), e.g. the Amazon CloudFront.

It is further proposed that the filter function applies a plurality of filter rules to the captured event, whereby even complex factual circumstances can be shown.

Furthermore it is proposed that the filter function filters the captured event by means of a location information of the mobile computing device, as a result of which the processing procedure can be triggered in a particularly end user orientated manner. A “location information” is in particular to be understood as an information describing where in the real world the mobile computing device is located.

It is further proposed that the filter function filters the captured event using at least one end user information of the mobile computing device, as a result of which the processing procedure can be triggered in a particularly end user orientated manner.

In an advantageous implementation of the invention it is proposed that the filter function is configurable by an offeror, as a result of which the offeror can especially advantageously start and design the processing procedure. By “configurable” it is in particular to be understood that the offeror can modify at least the filter rules of the filter function, in particular via the configuration computing device. An “offeror” is to be understood as a person who offers a performance which changes the real world, e.g. a dispatch of goods or manufacturing of goods.

It is proposed in a further embodiment that the filter function is configurable by an end user, such that the end user can especially advantageously start and implement the processing procedure. In particular, an “end user” is to be understood as a person who, in at least one operating state, mandates the offeror with a service via an event management system.

It is further proposed that an offeror application administration receives an offeror application configuration and generates an offeror application configured by means of the offeror application configuration, as a result of which a variety of offeror applications can be generated in a simple way. An “offeror application administration” is in particular to be understood as a device which is provided to administrate at least a configuration of an offeror application. The offeror application administration is advantageously provided to administrate configurations of a plurality of offerors. In particular, the offeror application administration makes configuration possibilities influencing a structure, a look and/or a behavior of the offeror application available to the offeror. The offeror application administration preferably comprises at least a server which is connected to the internet. Advantageously the offeror application administration has an interface via which a configuration computing device, in particular a web browser of the configuration computing device, retrieves, in a configuration process, a configuration surface from the offeror application administration. The offeror application administration is in particular provided to communicate with a plurality of configuration computing devices simultaneously. In particular the offeror application administration and the configuration computing devices form a client-server structure. In particular, an “offeror application administration” is to be understood as an information which adjusts the structure, the look and/or the behavior of the offeror application. The offeror application administration preferably comprises templates for the structure, the look and/or the behavior of the offeror application which is to be generated, which templates are combined to an offeror application configuration by the offeror. By “configured” it is to be understood that the offeror application generated has the structure, the look and/or the behavior determined by the offeror by means of the offeror application configuration. In particular, an “offeror application” is to be understood as an event capturing application which is configured substantially by the offeror. The offeror application is implemented as a computer program executable by the mobile computing device. In particular, the offeror application is at least provided to capture the event-relevant information, to send it to the event management device and/or to an event capturing device and to at least partially present an offeror information to the end user.

It is further proposed that the mobile computing device carries out the offeror application, as a result of which the offeror application can advantageously be used by the end users.

Moreover, it is proposed that the offeror application sends the event-relevant information, which allows advantageous processing of the event-relevant information.

In a further embodiment it is proposed that the offeror application administration distributes the offeror application to a plurality of application distributors, which allows the offeror to be relieved. An “application distributor” is to be understood as a server or several servers from which a plurality of mobile computing devices may download the offeror application. Preferentially the application distributor offers a great number of different applications to the mobile computing devices. By the term “distribute” it is in particular to be understood that the offeror application administration sends the offeror application to a variety of application distributors. As an alternative, the offeror could download the offeror application from the offeror application administration and distribute it to the application distributors, e.g. via uploading onto websites of the application distributors.

Furthermore, it is proposed that the mobile computing device installs the offeror application from one of the application distributors, thus allowing comfortable installation of the offeror application. The term “install from one of the application distributors” is in particular to be understood such that the mobile computing device downloads the offeror application from the application distributor and stores it in the memory in a form executable by the processor. Alternatively or additionally, the offeror application could be installed on the mobile computing device from a data carrier, and/or could be integrated in an operative system of the mobile computing device, for example if the mobile computing device is integrated in a motor vehicle.

It is further proposed that the offeror application configuration, in at least one operating state, allocates the captured event of the event-relevant information and the processing procedure which influences the real world to each other. Due to said allocation, the end user can particularly comfortably be supplied with offers and/or information of the offeror at low computing effort. By “allocate to each other” it is in particular to be understood that the offeror can adjust, by means of the offeror application configuration, which processing procedure or which processing procedures can follow which recorded event.

In a further embodiment it is proposed that the mobile computing device has an offeror application configured by an offeror, which offeror application comprises at least one event function, as a result of which offeror information as well as an accordingly configured offeror application can advantageously be offered to the end user. In particular the offeror application can capture event-relevant information which is suitable to the offeror information.

### DRAWINGS

Further advantages may be gathered from the following description of the drawings. In the drawings, an exemplary embodiment of the invention is shown. The drawings, the description and the claims contain numerous features in combination. The person skilled in the art will purposefully consider each feature individually and will combine the features to further expedient combinations.

The following features are shown in the drawings:

FIG. 1 A schematic overview of an event management system according to the invention with a mobile computing device and an event management device,

FIG. 2 another image of the event management system according to the invention of FIG. 1,

FIG. 3 a schematic image of the mobile computing device of FIG. 1,

FIG. 4 a schematic image of a method according to the invention with the event management system of FIG. 1,

FIG. 5 a partial image of the method according to the invention of FIG. 4, wherein capturing of an event-relevant information is carried out in dependence on an end user input, and

FIG. 6 a further partial image of the method according to the invention of FIG. 4, wherein capturing of an event-relevant information is carried out independently from an end user input.

### DESCRIPTION OF THE EXEMPLARY EMBODIMENT

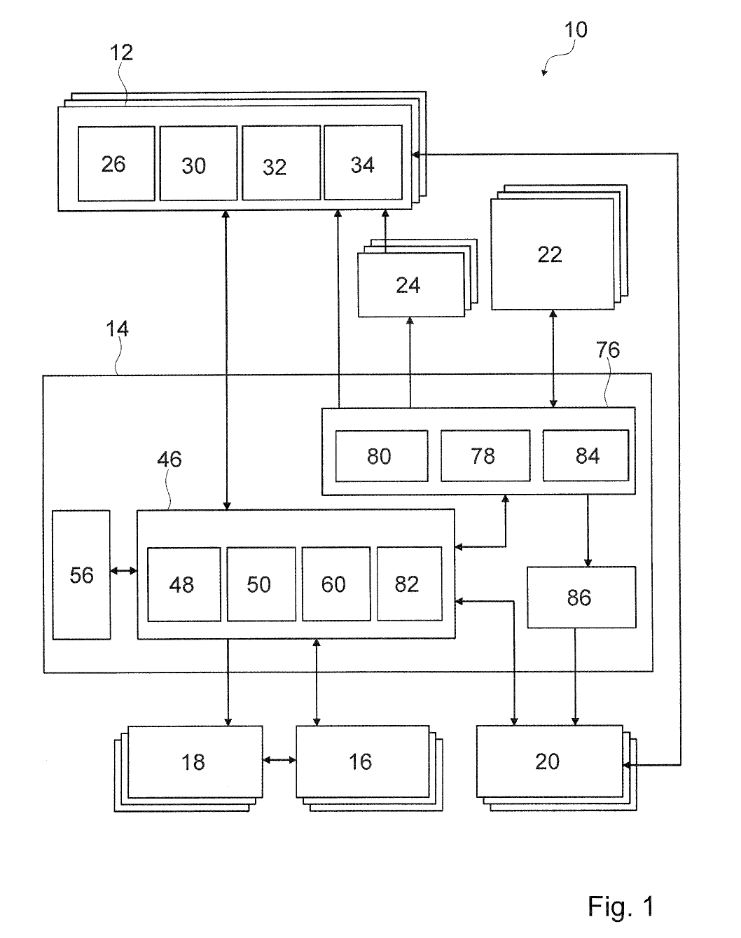

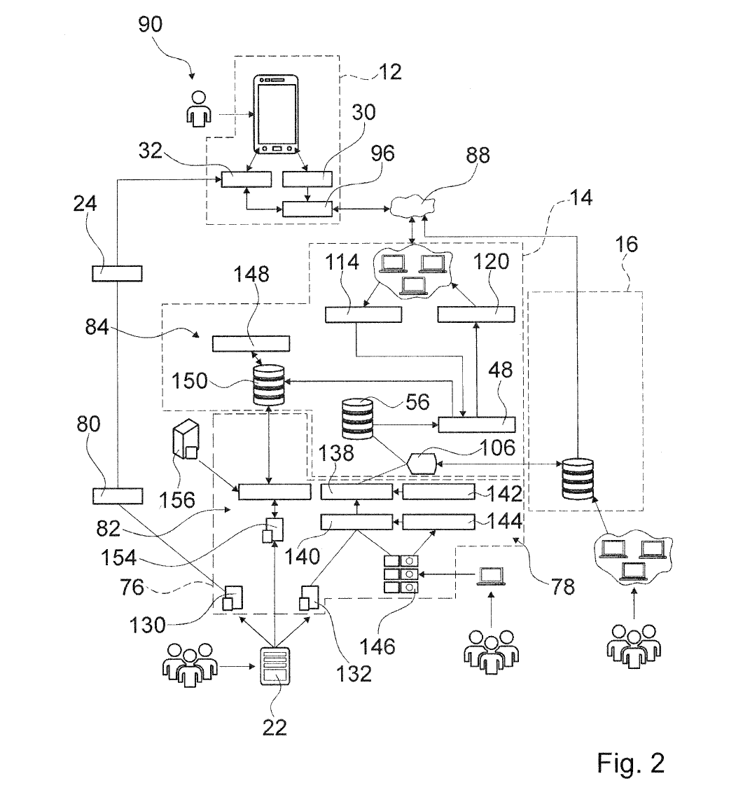

FIGS. 1 and 2 show an event management system 10 with several mobile computing devices 12, with an event management device 14, with several offeror information devices 16, with at least one financial transaction device 18, with several event capturing devices 20, with several configuration computing devices 22 and with several application distributors 24. The mobile computing devices 12, the event management device 14, the offeror information devices 16, the financial transaction device 18, the event capturing devices 20, the configuration computing devices 22 and the application distributors 24 are connected to each other via a WAN 88, in this case the internet. The arrows depicted in FIG. 1 show interfaces (APIs) between the devices of the event management system 10. A direction of the arrows herein shows a main direction of an information flow over the respective interface. The event management device 14, the financial transaction device 18, the event capturing devices 20 and the application distributors 24 are each embodied as one or several servers connected to the WAN.

The mobile computing devices 12 are implemented as smartphones, tablet computers and/or laptop computers. The mobile computing devices 12 have a communication means 92 which is provided to create a data connection at least to the event management device 14 via the WAN 88, in this case via a mobile communications network and/or a WLAN network. Each of the mobile computing devices 12 comprises an output unit 94 with a display and a loudspeaker which are provided to output information to an end user 90. The mobile computing devices 12 have a plurality of sensors 26 for capturing an event-relevant information 28. The sensors 26 are embodied as a camera, as a microphone, as a real-time clock, as an acceleration sensor, as an air-pressure sensor, as a compass and/or as a satellite navigation receiver.

The mobile computing devices 12 each comprise at least one event capturing application 30, 32, 34. The mobile computing devices 12 receive installation data of one of the event capturing applications 30, 32, 34 from one of the application distributors 24. The mobile computing devices 12 install, if applicable in dependence on an end user input, and carry out the event capturing applications 30, 32, 34. An operating system 96 of the mobile computing devices 12 is provided to carry out at least one of the event capturing applications 30, 32, 34.

The installable event capturing applications 30, 32, 34 are implemented as an end user application 30, as an offeror application 32 and/or as an event recognizing application 34.

An end user capturing configuration 36, which configures capturing of the event-relevant information 28 of the end user application 30, is at least substantially configurable by the end user 90. An application configuration 102 of the end user application 30 is at least partially configurable by the end user 90. Moreover, end user filter rules 38, which configure filtering of events captured by the end user application 30, are at least substantially configurable by the end user 90. The end user capturing configuration 36, the end user filter rules 38 and/or the application configurations 102 are adjustable by the end user 90 via an input means of the mobile computing device 12. Alternatively or additionally the end user capturing configuration 36 and/or the end user filter rules 38 could be configurable via an internet server (not shown in detail) which is connected to the end user application 30 and which provides an end user application administration, in particular a website, with an administration presentation that is retrievable by the end user 90.

A design and a structure of the offeror application 32, namely application configurations 104 of the offeror application 32, are at least substantially configurable by an offeror of the offeror application 32 via an offeror application configuration 40. An offeror capturing configuration 42 which configures capturing of the event-relevant information 28 of the offeror application 32 is at least substantially configurable by the offeror of the offeror application 32. The offeror capturing configuration 42 comprises at least one event description 106, preferably a plurality of event descriptions 106. The event descriptions 106 are each implemented as an information which the event-relevant information 28 is searched for in order to capture the event.

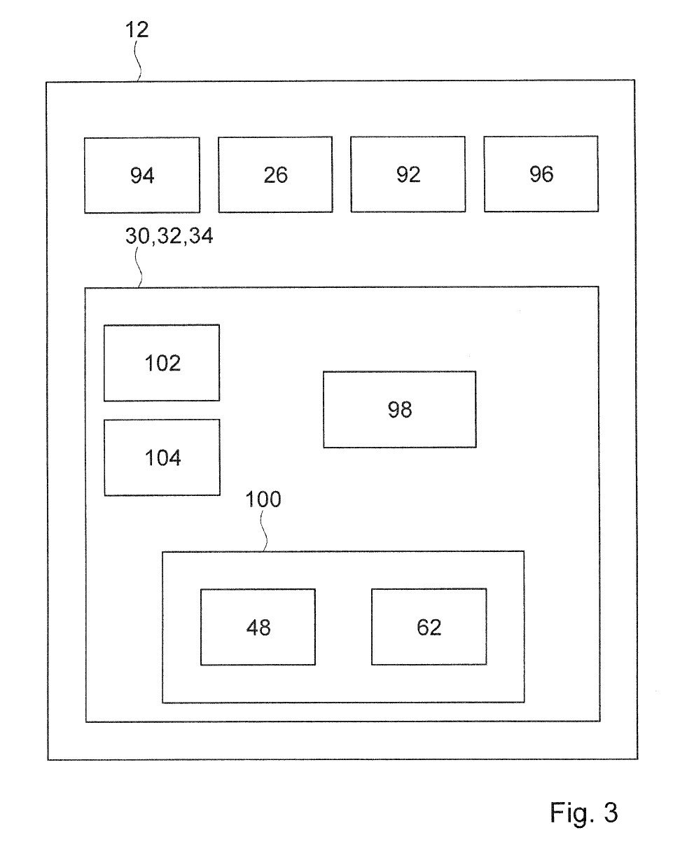

As is shown in FIG. 3, the end user application 30 and the offeror application 32 have a shared basis routine 98, a shared event function routine 100 and each have an application configuration 102, 104. As an alternative, each of the end user application 30 and the offeror application 32 could have a respective basis routine and/or a respective event function routine. The basis routine 98 is embodied as a PhoneGap instance. The event function routine 100 communicates, in particular by way of the operating system 96, with the sensor 26, the communication means 92 and the output unit 94. The event function routine 100 is embodied as a plug-in of the basis routine 98. The event function routine 100 is provided to supply the functions according to the invention of the end user application 30 and the offeror application 32. The event function routine 100 comprises a substantial functional programming of the end user application 30 and the offeror application 32.

It depends at least on which of the application configurations 102, 104 loads the basis routine 98, whether the basis routine 98 shows the end user application 30 and the offeror application 32. Via further application configurations (not shown in detail), further end user applications and offeror applications may be provided on the mobile computing device 12. Each of the application configurations 102, 104 comprises at least a presentation of the end user application 30 or of the offeror application 32. Each of the application configurations 102, 104 has a different end user interface information. The end user interfaces have at least texts, graphic elements and a navigation structure. Furthermore, end user interface information has media elements as for example videos and/or a sound track. The basis routine 98 presents the end user interface information to the end user 90 and guides the end user 90 through the navigation structure.

The application configurations 102, 104 further comprise a variety of functional elements which can be implemented in a variety of manners, in this case as JavaScript routines. By means of the functional elements, a variety of functions can be assigned to the end user application 30 and to the offeror application 32, even while the basis routine 98 and in particular the event function routine 100 do not have to be implemented differently. As an alternative, the event capturing applications 30, 32, 34 may have different event function routines 100.

Furthermore, offeror filter rules 44 which configure filtering of captured events 50, which have been captured by the offeror application 32, are configurable at least substantially by the offeror of the offeror application 32. One of the mobile computing devices 12 may have several offeror applications 32 from different offerors.

The event recognizing application 34 is embodied as an application of a third party offeror. The event recognizing application 34 is provided to forward the event-relevant information 28 directly to the event capturing device 20. The event capturing device 20 has an interface by means of which the event capturing device 20 communicates with the mobile computing device 12 directly. The event capturing device 20 is implemented separately from the event management device 14. The event recognizing application 34 has another interface by means of which the event recognizing application 34 communicates with the event management device 14 after an event has been captured. Alternatively or additionally the event capturing device 20 could have an interface by which the event capturing device 20 communicates with the event management device 14 after an event has been captured. Preferentially the event recognizing application 34 sends at least an end user input 70 to the event management device 14, either directly or alternatively via the event capturing device 20.

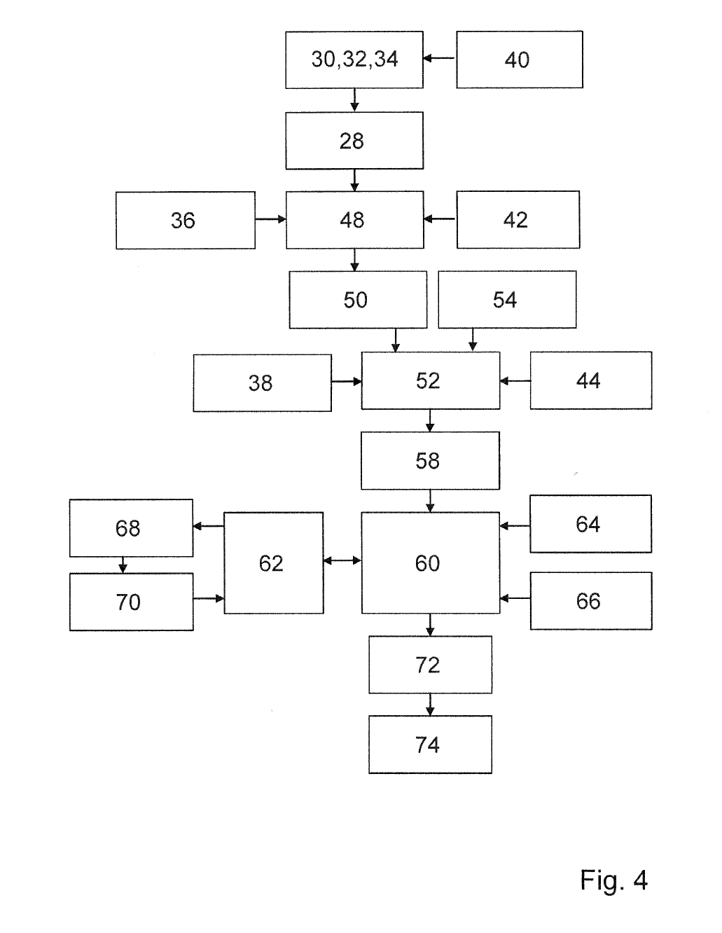

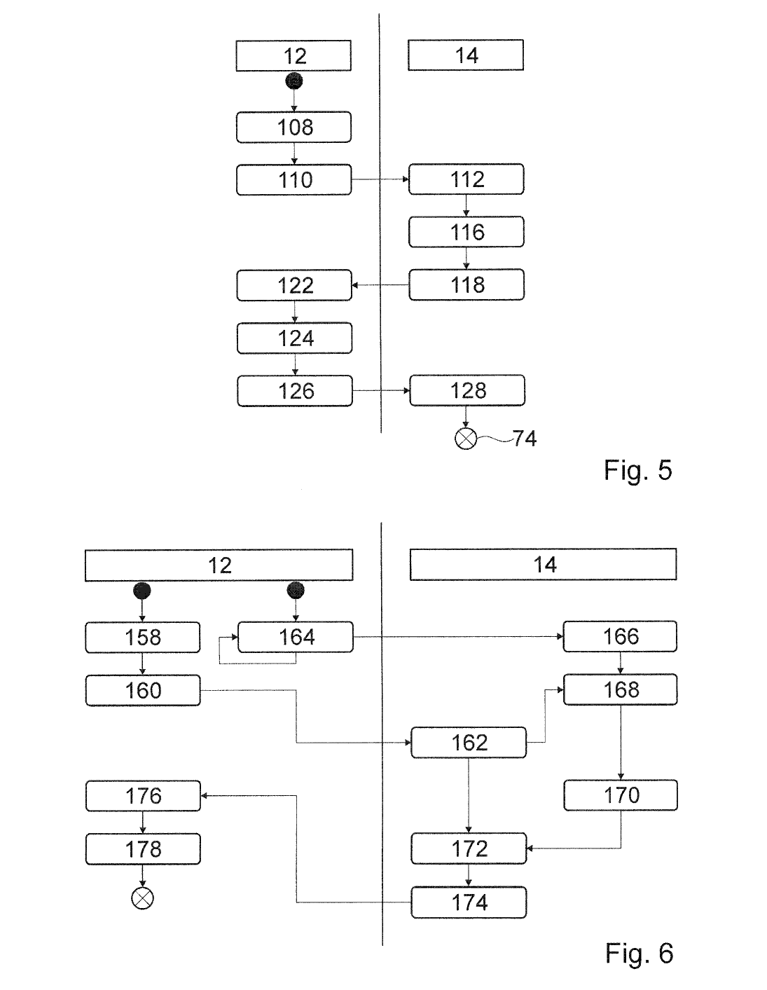

FIG. 4 shows a method for processing the event-relevant information 28. The event capturing application 30, 32, 34 captures an event-relevant information 28 which describes the real world. As shown in FIG. 5, capturing of the event-relevant information 28 can herein be initiated by an end user 90 in a method step 108, for example by capturing an object via the sensor 26 of the mobile computing device 12. The corresponding event capturing application 30, 32, 34, in particular the event function routine 100 of the event capturing application 30, 32, generates an event-relevant information 28 implemented as an information package which at least partially comprises the information detected via the sensor 26.

The event capturing application 30, 32, 34 of the mobile computing device 12 sends, in a following method step 110, the event-relevant information 28 to the event management device 14 or alternatively to the event capturing device 20. The event management device 14 or the event capturing device 20 receives, in a following method step 112, the event-relevant information 28. To this purpose, an event management application 46 has a receiving routine 114 which is provided for receiving messages from the mobile computing device 12.

In the following, the capturing and processing of the event-relevant information 28 in a next method step 114, based on processing by the event management device 14, is described. The method step 116 for capturing the event could also be carried out partially by the event capturing device 20.

The event management device 14 has an event management application 46 with an event capturing function 48, which is provided to capture an event in the event-relevant information 28. To this purpose the event capturing function 48 compares the event described by the event-relevant information 28 with the event descriptions 106. If the event description 106 is at least substantially found in the event-relevant information 28, the event is taken as captured. The event capturing function 48 outputs, as a result of the capturing, an information package which is herein designated as a captured event 50. For comparing the event-relevant information 28 and the event descriptions 106, methods are applied which are dependent on a data type of the event-relevant information 28 and which are deemed expedient by the person skilled in the art, e.g. at least methods which are known from the field of “augmented reality”.

The event capturing function 48 is provided to capture, depending on a medium of the event-relevant information 28, an event in the event-relevant information 28 of its own accord and/or to forward the event-relevant information 28 to the event capturing device 20, which is suitable for capturing the event of the event-relevant information 28. In this case the event capturing device 20 sends a message containing the captured event 50 to the event management device 14. Alternatively or additionally the event capturing application of the mobile computing device 12 could have an event capturing function and could send a captured event to the event management device 14 or could process a captured event on its own accord.

Examples for captured events 50:
Recognizing an image in a video track.
Recognizing a 3D model in a video track, in particular a 3D video track.
Identifying a sound in a sound track.
Sojourn in a certain place or area
Reaching a point in time.
Recognizing a movement profile.
Further events deemed expedient by the person skilled in the art.

The event management application 46 has a filter function 52. Alternatively or additionally the event capturing application 30, 32, 34 could have a filter function. The filter function 52 is provided to check the captured event 50 using filter rules. The filter function 52 is provided to consider additional event information 54 when filtering the captured event 50. The additional event information 54 can be embodied as information contained in the event-relevant information 28. Furthermore, the additional event information 54 can have sensor information obtained by the sensors 26. The additional event information 54 can also be implemented as data stored in a database 56 of the event management device 14, e.g. as a collection of end user information. The database 56 is embodied as a non-relational database (NoSQL database).

One of the filter rules is implemented as the end user filter rule 38, i.e. the end user 90 can set the filter rule, in particular via the mobile computing device 12 of the end user 90. The filter function 52 is thus configurable by the end user 90. One of the filter rules is implemented as an offeror filter rule 44, i.e. the offeror can set the filter rule. The filter function 52 is thus configurable by the offeror.

Depending on a filtering result of the filter rules, a filtered event 58 is further processed in a variety of manners by an event function 60 of the event management application 46 and/or by an event function 62 of the mobile computing device 12. The event function 60 of the event management application 46 sends, in particular in dependence on the captured event 50, on the additional event information 54 and/or on an offeror event configuration 64, an offeror information 66 to the mobile computing device 12.

The event function 60 of the event management application 46 requests, in particular in dependence on the offeror event configuration 64, the offeror information 66 from the offeror information device 16. Alternatively or additionally, the event function 60 could, as shown in FIG. 2, request a reference to the offeror information 66, in particular a link to an internet address. Herein the request for the reference to the offeror information 66 can be carried out before the reference is sent to the offeror information 66 or advantageously when the event description 106 is entered into the database 56 by the offeror. In particular the database 56 stores, in an operative state, the offeror event configuration 64 with the reference to the offeror information 66, at least the event description 106 and in particular further information deemed expedient by the person skilled in the art.

To this purpose, the event management device 14 and the offeror information device 16 are connected to each other via an interface. The offeror event configuration 64 describes at least which of the offeror information devices 16 provides the offeror information 66, in particular by the reference. The event management device 14 is provided to request and receive offeror information 66 or references to offeror information 66 from offeror information devices 16 which are implemented and structured in a variety of manners. To this purpose, the event management device 14 is provided to communicate with the offeror information devices 16 using different protocols. Alternatively or additionally the event management device 14 could have a defined interface via which the event management device 14 and the offeror information devices 16 communicate.

If said comparison results in a matching value which says that there is a captured event 50, the event management device 14 sends, in a further method step 118, a message with an offeror information 66 as an answer to the mobile computing device 12. If the comparison results in a matching value which says that there is no captured event, the event management device 14 sends a message conveying this fact. For sending the message, the event management application 46 has a sending routine 120 provided to send messages to the mobile computing device 12.

In a further method step 122 one of the event capturing applications 30, 32, 34 receives the message with the offeror information 66 and presents it to the end user 90 in an interpretation by the basis routine 98. The basis routine 98 and/or the event function 62 of the mobile computing device 12 outputs an offeror information presentation 68 to the end user 90, e.g. a video, an operation manual, an offer, a payment dialogue and/or a menu with different choices for the end user 90 to select from. The offeror information presentation 68 loads the event capturing application 30, 32, 34 using the reference from the offeror information device 16, or the offeror information presentation 68 is part of the offeror information 66 received.

In dependence on the offeror information presentation 68, the end user 90 carries out an end user input 70 in a following method step 124. In a next method step 126 the event capturing application 30, 32, 34 sends the end user input 70 to the event management device 14. The event function 60 of the event management application 46 processes the end user input 70. Alternatively or additionally the event function 62 of the mobile computing device 12 could at least partially process the end user input 70. In dependence on offeror event configuration 64 and end user input 70, the event function 62 of the mobile computing device 12 once again presents a new offeror information presentation 68 or new portions of the offeror information presentation 68 to the user, once or several times. The event function 62 of the mobile computing device 12 sends an end user input information 72 to the event management device 14, at least when the end user input 70 of the event 58 has been completed.

In a method step 128, the event management device 14 receives the end user input information 72. The event function 60 starts a processing procedure 74, in dependence on the end user input information 72. The processing procedure 74 influences the real world. To this purpose, the processing procedure 74 sends at least one order to influence the real world. The processing procedure 74 sends, for example, an order for a financial transaction to the financial transaction device 18 and sends an order for dispatching goods to the offeror information device 16. As an alternative, the processing procedure 74 could influence the real world using an information of the end user 90 about the real world.

Examples for captured events 50, filter rules and orders resulting therefrom:
Event: Sojourn in a certain area around a business place of the offeror.
Filter rule: Start processing procedure 74 if an interest in a product of said business place is stored in the end user information.
Order: Send an offer valid in the real world to the end user 90.
Event: It is lunchtime.
Filter rule: Start processing procedure 74 if the end user 90 is located near a restaurant of the offeror.
Order: Show the end user 90 a map with a route to the restaurant and an offer of the restaurant.
Event: Contents of a tank of a motor vehicle having the mobile computing device is below a threshold value.
Filter rule: Check regularly if tank contents minus reserve tank contents are sufficient for reaching the nearest gas station.
Order: Warn the end user driving the motor vehicle if he has to start on the reserve tank contents for driving to the gas station.

The event management device 14 has an offeror application administration 76. The offeror application administration 76 has a configuration function 78 which provides the offeror with configuration surfaces 130, 132, which can be presented at least on the configuration computing device 22. The configuration surfaces 130, 132 are embodied as an internet site. The configuration function 78 has a “rich internet application” deemed expedient by the person skilled in the art, e.g. “Sencha”.

The event management device 14 has at least one interface via which, in a configuration, the configuration computing device 22 communicates with the configuration function 78. The offeror application configuration 40 is adjustable and/or modifiable by the offeror by means of the configuration function 78, in particular by means of one of the configuration surfaces 130. Thereby a structure of the offeror application 32 of the offeror can be adapted by the end user 90 and/or a new offeror application configuration 40 can be generated for a new offeror application 32. By the configuration function 78, in particular using one of the configuration surfaces 132, the offeror can adjust and/or modify the offeror capturing configuration 42, as a result of which it is for example possible to define new events to be captured. To this purpose, the configuration computing device 22 sends at least an event description 106 to the configuration function 78. The configuration function 78 stores the event description 106 in the database 56.

The configuration computing device 22 further advantageously sends the configuration function 78 a reference to the offeror information 66, which reference is assigned to the event description 106. The configuration function 78 sends the event description 106 to the event management application 46 and/or to the event capturing device 20.

The configuration function 78 comprises an event generator 138, an event generator interface 140 and a plug-in interface 142. The event generator 138 generates the event description 106, following information of the offeror. To this purpose, the event generator 138 indexes the information of the offeror. The event generator interface 140 is provided to receive the information of the offeror. The event generator interface 140 has a mass event generator interface 144, via which a great number of information of the offeror can be received simultaneously. Moreover, the configuration function 78 has an external interface 146 via which further systems, which are not shown, can send event descriptions 106 to the event management device 14 in an automated manner.

By means of the configuration function 78, the offeror filter rule 44 is adjustable and/or modifiable by the offeror. Captured events 50, sensor information of the sensors 26 and additional event information 54 can thus be linked to each other by the offeror via the configuration function 78, in order to start and carry out the event functions 60, 62. The filter function 52 enables the offeror to link a plurality of different characteristics of real-world things and to influence the real world via the event functions 60, 62, in dependence on said linkage. The end user 90 may thus be informed in a particularly tailor-made manner, and can influence the real world vial the mobile computing device 12 particularly comfortably. In particular, low computing effort is thus achieved in contrast to established methods which do not comprise event recognizing.

By way of the configuration function 78, the offeror can modify the offeror event configuration 64. The offeror event configuration 64 influences which offeror information 66 is sent to the event function 62 of the mobile computing device 12 by the event function 60 of the event management application 46. The offeror can furthermore send the offeror information 66 to the event management application 46 via the configuration function 78. In this case, the event management application 46 stores the offeror information 66 in the database 56. The end user 90 can, for example, using the configuration function 78, upload an operation manual, configure the interface from the event management device 14 to the offeror information device 16 and/or define a retrieval dialogue for retrieving an end user input 70. Via the configuration function 78, at least captured events 50 and/or end user inputs 70 can be allocated to a processing procedure 74 and thereby advantageously to an order.

Moreover, the offeror application administration 76 has an application generator 80 which is provided to generate, in dependence on the offeror application configuration 40, a plurality of offeror applications 32 suitable for different operating systems of mobile computing devices 12. To this purpose the application generator 80 generates the application configuration 102, 104. The offeror application administration 76 is provided to distribute the offeror applications 32 to application distributors 24 of the different operating systems. The application distributors 24 supply the end user 90 with the offeror applications 32 ready for installation.

The event management device 14 has a statistics and analysis function 82. The statistics and analysis function 82 collects information about captured events 50, filtered events 58 and/or processing procedures 74. The statistics and analysis function 82 comprises an evaluation routine 148 and a statistics database 150. The event capturing function 48 sends information about captured events 50 to the evaluation routine 148. The evaluation routine 148 analyzes the information in a manner that is deemed expedient by the person skilled in the art. In particular, the evaluation routine 148, or alternatively the event capturing function 48, anonymizes the captured events 50. The evaluation routine 148 stores statistical data in the statistics database 150.

The offeror application administration 76 has a statistics and analysis function 84 which is provided to display the information collected by the statistics and analysis function 82 of the event management device 14 to the offeror. The statistics and analysis function 84 of the offeror application administration 76 has a statistics interface 152 providing a presentation surface 154. The presentation surface 154 is implemented as a website. The statistics interface 152 is further intended to communicate with external statistics databases 156 or with other systems, e.g. marketing offerors, deemed expedient by the person skilled in the art.

The event management device 14 has an event description administration 86. The event description administration 86 receives event information, which is evaluated by the event capturing devices 20, from the offeror application administration 76. The event description administration 86 is provided to adapt the event description 106 to the different event capturing devices 20. The event description administration 86 has a variety of interfaces for communicating with the different event capturing devices 20. The event description administration 86 distributes the event description 106 to the different event capturing devices 20.

As shown in FIG. 6, capturing of the event-relevant information 28 can be effected independently from an end user input 70, as e.g. a regular capturing of a location by the satellite navigation receiver of the mobile computing device 12. In a first method step 158 the end user 90 or the event capturing applications 30, 32, 34 activate independent capturing of the event-relevant information 28. In a method step 160 the respective event capturing application 30, 32, 34 sends a message to the event management device 14 that it will regularly send event-relevant information 28 in the future. The message says to which purposes this event-relevant information 28 may be used, i.e. which event descriptions 106 the event-relevant information 28 is to be compared to. The event management device 14 receives the message in a further method step 162 and configures the event function 60 of the event management device 14. The activation of the independent capturing and its configuration is stored in the end user information. An adjustment is effected saying which event descriptions 106 the event-relevant information 28 received in the future will have to be compared to, and an address for an answer to the event-relevant information 28 is stored.

Following this configuration, the mobile computing device 12 regularly sends, in a method step 164, the independently captured event-relevant information 28 to the event management device 14. The mobile computing device 12 receives the event-relevant information 28 in a further method step 166. The mobile computing device 12 then checks in a method step 168 whether the event-relevant information 28 is, according to one of the event descriptions 106, a captured event 50. If this is the case, the mobile computing device 12 generates, in a following method step 170, a message containing an offeror information 66 allocated to the captured event 50. In a further method step 172 the message is addressed to the mobile computing device 12. In a next method step 174 the message containing the offeror information 66 is sent to the mobile computing device 12. The mobile computing device 12 receives the message containing the offeror information 66 in a further method step 176. The mobile computing device 12 at least partially presents the offeror information 66 to the end user 90 in a following method step 178.

### REFERENCE NUMERALS

10 event management system
12 computing device
14 event management device
16 offeror information device
18 financial transaction device
20 event capturing device
22 configuration computing device
24 application distributor
26 sensor
28 event-relevant information
30 end user application
32 offeror application
34 event recognizing application
36 end user capturing configuration
38 end user filter rule
40 offeror application configuration
42 offeror capturing configuration
44 offeror filter rule
46 event management application
48 event capturing function
50 captured event
52 filter function
54 additional event information
56 database
58 filtered event
60 event function
62 event function
64 offeror event configuration
66 offeror information
68 offeror information presentation
70 end user input
72 end user input information
74 processing procedure
76 offeror application administration
78 configuration function
80 application generator
82 statistics and analysis function
84 statistics and analysis function
86 event description administration
88 WAN
90 end user
92 communication means
94 output unit
96 operative system
98 basis routine
100 event function routine
102 application configuration
104 application configuration
106 event description
108 method step
110 method step
112 method step
114 receiving routine
116 method step
118 method step
120 sending routine
122 method step
124 method step
126 method step
128 method step
130 configuration surface
132 configuration surface
138 event generator
140 event generator interface
142 plugin interface
144 mass event generator interface
146 external interface
148 evaluation routine
150 statistics database
152 statistics interface
154 presentation surface
156 statistics database
158 method step
160 method step
162 method step
164 method step
166 method step
168 method step
170 method step
172 method step
174 method step
176 method step
178 method step

1. A method with a mobile computing device which sends at least an event-relevant information, wherein an event capturing device receives the event-relevant information, searches the event-relevant information for an event by means of an event description and sends a captured event to an event management device, wherein the event management device on receiving the captured event carries out a filter function which filters the captured event by means of at least one filter rule, wherein an offeror information, which is dependent on the filtered event and has been sent by an offeror information device, is sent to the mobile computing device, wherein the mobile computing device, in dependence on the offeror information, carries out at least one event function which at least partially presents the offeror information to an end user, captures an end user input and sends the end user input to the event management device, wherein the event management device carries out a processing procedure which is dependent on the end user input and influences the real world by sending an order for a financial transaction to a financial transaction device and sending an order for a dispatch of goods to the offeror information device.

2. The method according to claim 1, wherein the event management device receives the offeror information from the offeror information device.

3. The method according to claim 1, wherein the filter function applies a plurality of filter rules to the captured event.

4. The method according to claim 1, wherein the filter function filters the captured event by means of a location information of the mobile computing device.

5. The method according to claim 1, wherein the filter function filters the captured event using at least one end user information of the mobile computing device.

6. The method according to claim 1, wherein the filter function is configurable by an offeror.

7. The method according to claim 1, wherein the filter function is configurable by the end user.

8. The method according to claim 1, further comprising:
an offeror application administration which receives an offeror application configuration and generates an offeror application configured by means of the offeror application configuration.

9. The method according to claim 8, wherein the mobile computing device carries out the offeror application.

10. The method according to claim 8, wherein the offeror application sends the event-relevant information.

11. The method according to claim 8, wherein the offeror application administration distributes the offeror application to a plurality of application distributors.

12. The method according to claim 11, wherein the mobile computing device installs the offeror application from one of the application distributors.

13. The method according to claim 8, wherein the offeror application configuration, in at least one operating state, allocates the captured event of the event-relevant information and the processing procedure which influences the real world to each other.

14. An event management system comprising:
at least one mobile computing device,
an event management device,
an offeror information device,
a financial transaction device, and
an event capturing device, wherein
the mobile computing device is provided to send an event-relevant information,
the event capturing device is provided to receive the event-relevant information, to search the event-relevant information for an event by means of an event description and to send a captured event to the event management device,
the event management device on receiving the captured event carries out a filter function which filters the captured event by means of at least one filter rule,
the offeror information device sends an offeror information which is dependent on the filtered event to the mobile computing device,
the mobile computing device is provided to carry out, in dependence on the offeror information, an event function which in at least one operating state at least partially presents the offeror information to an end user, captures an end user input and sends the end user input to the event management device, and
the event management device carries out a processing procedure which is dependent on the end user input and influences the real world by sending an order for a financial transaction to the financial transaction device and sending an order for a dispatch of goods to the offeror information device.

15. The event management system according to claim 14, wherein the mobile computing device has an offeror application configured by an offeror, which comprises at least the event function.

16. An event management device of an event management system at least according to claim 14.

17. The method according to claim 2, wherein the filter function applies a plurality of filter rules to the captured event.

18. The method according to claim 2, wherein the filter function filters the captured event by means of a location information of the mobile computing device.

19. The method according to claim 3, wherein the filter function filters the captured event by means of a location information of the mobile computing device.

20. The method according to claim 2, wherein the filter function filters the captured event using at least one end user information of the mobile computing device.
